(19) United States
(12) Patent Application Publication
(10) Pub. No.: US 2025/0330764 A1
(43) Pub. Date: Oct. 23, 2025

(54) AUDIO SIGNAL PROCESSING

(71) Applicant: Nokia Technologies Oy, Espoo (FI)

(72) Inventors: Tapani PIHLAJAKUJA, Espoo (FI); Jussi Artturi LEPPÄNEN, Tampere (FI); Arto Juhani LEHTINIEMI, Tampere (FI)

(21) Appl. No.: 19/174,161

(22) Filed: Apr. 9, 2025

(30) Foreign Application Priority Data
Apr. 23, 2024 (GB) 2405677.2

(51) Int. Cl. H04S 7/00

(52) U.S. Cl. CPC H04S 7/303; H04S 2420/01

(57) ABSTRACT

Example embodiments relating to audio signal processing are disclosed. For example, a method may comprise receiving an audio signal, and receiving, from a plurality M of devices, respective requests for a spatial audio signal, wherein the respective requests indicate respective user head orientations. The method may further comprise determining a plurality N of reference head orientations, wherein N<M and processing the received audio signal to obtain a plurality of spatial audio signals respectively associated with the plurality N of reference head orientations and a plurality of sets of metadata respectively associated with the plurality of spatial audio signals. The method may further comprise transmitting, to at least one of the devices, a selected spatial audio signal and associated metadata, wherein the selection is based on which reference head orientation is most closely associated with the user head orientation indicated in the request from the at least one device.

### FIELD

Example embodiments relate to audio signal processing.

### BACKGROUND

Spatial audio refers to audio which, when output to a user device such as a pair of earphones, enables a user to perceive audio sources as coming from respective directions with respect to the user's position. For example, one audio source may be perceived as coming from a position in front of the user whereas one or more other audio sources may be perceived as coming from positions to the left and/or right-hand side of the user. Spatial audio can be more complex to transmit, decode and render than other audio formats and hence split rendering methods have been proposed whereby the rendering operation may be divided into different stages, wherein the different stages are performed by different apparatuses.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect, there is described an apparatus comprising: means for receiving an audio signal; means for receiving, from a plurality M of devices, respective requests for a spatial audio signal, wherein the respective requests indicate respective user head orientations; means for determining a plurality N of reference head orientations, wherein N<M; means for processing the received audio signal to obtain: a plurality of spatial audio signals respectively associated with the plurality N of reference head orientations; and a plurality of sets of metadata respectively associated with the plurality of spatial audio signals, wherein a set of metadata comprises information indicating how the associated spatial audio signal should be adjusted to account for a change in head orientation related to the associated reference head orientation; and means for transmitting, to at least one of the devices, a selected spatial audio signal and associated metadata, wherein the selection is based on which reference head orientation is most closely associated with the user head orientation indicated in the request from the at least one device.

In some example embodiments, the apparatus may further comprise means for detecting that the plurality M of devices comprises a number greater than a threshold number G, wherein the processing is performed responsive to the detecting.

In some example embodiments, the plurality N of reference head orientations may comprise a number equal to the threshold number G.

In some example embodiments, the plurality N of reference head orientations may be determined in advance of receiving the respective requests.

In some example embodiments, the plurality N of reference head orientations may be determined based at least in part on the respective user head orientations indicated in the respective requests.

In some example embodiments, the plurality N of reference head orientations may be determined by: arranging the plurality M of user head orientations into N groups of one or more user head orientations, wherein at least one group comprises two or more user head orientations; and determining respective reference head orientations for the N groups, wherein the reference head orientation for said at least one group comprising two or more reference head orientations is determined based on at least one of said two or more reference head orientations.

In some example embodiments, the reference head orientation for said at least one group may comprise one of the respective user head orientations.

In some example embodiments, the reference head orientation for said at least one group may comprise an average of the respective user head orientations.

In some example embodiments, the at least one group may comprise two or more respective head orientations which are most similar or are within a similarity threshold.

In some example embodiments, the arranging may comprise: determining directional vectors associated the respective user head orientations received from the plurality M of devices; identifying which of a first set of spatial sectors corresponds to the largest number of directional vectors; dividing the identified spatial sector into two or more spatial sectors; and if the number of spatial sectors is not equal to N, re-performing the identifying and dividing operations until the number of spatial sectors is equal to N.

In some example embodiments, the selected spatial audio signal for a particular device may be that associated with the reference head orientation of the group into which the respective user head orientation from the particular device is arranged.

In some example embodiments, the reference head orientations may comprise orientations for at least one of: the yaw axis; the yaw and pitch axes; or the yaw, pitch and roll axes.

In some example embodiments, the apparatus may be comprised by at least one of a user device, or a server.

In some example embodiments, the plurality M of devices may be comprised by at least one of an earphones device, a loudspeaker device or a user device.

According to a second aspect, there is described a method comprising: receiving an audio signal; receiving, from a plurality M of devices, respective requests for a spatial audio signal, wherein the respective requests indicate respective user head orientations; determining a plurality N of reference head orientations, wherein N<M; processing the received audio signal to obtain: a plurality of spatial audio signals respectively associated with the plurality N of reference head orientations; and a plurality of sets of metadata respectively associated with the plurality of spatial audio signals, wherein a set of metadata comprises information indicating how the associated spatial audio signal should be adjusted to account for a change in head orientation related to the associated reference head orientation; and transmitting, to at least one of the devices, a selected spatial audio signal and associated metadata, wherein the selection is based on which reference head orientation is most closely associated with the user head orientation indicated in the request from the at least one device.

In some example embodiments, the method may further comprise detecting that the plurality M of devices comprises a number greater than a threshold number G, wherein the processing is performed responsive to the detecting.

In some example embodiments, the plurality N of reference head orientations may comprise a number equal to the threshold number G.

In some example embodiments, the plurality N of reference head orientations may be determined in advance of receiving the respective requests.

In some example embodiments, the plurality N of reference head orientations may be determined based at least in part on the respective user head orientations indicated in the respective requests.

In some example embodiments, the plurality N of reference head orientations may be determined by: arranging the plurality M of user head orientations into N groups of one or more user head orientations, wherein at least one group comprises two or more user head orientations; and determining respective reference head orientations for the N groups, wherein the reference head orientation for said at least one group comprising two or more reference head orientations is determined based on at least one of said two or more reference head orientations.

In some example embodiments, the reference head orientation for said at least one group may comprise one of the respective user head orientations.

In some example embodiments, the reference head orientation for said at least one group may comprise an average of the respective user head orientations.

In some example embodiments, the at least one group may comprise two or more respective head orientations which are most similar or are within a similarity threshold.

In some example embodiments, the arranging may comprise: determining directional vectors associated the respective user head orientations received from the plurality M of devices; identifying which of a first set of spatial sectors corresponds to the largest number of directional vectors; dividing the identified spatial sector into two or more spatial sectors; and if the number of spatial sectors is not equal to N, re-performing the identifying and dividing operations until the number of spatial sectors is equal to N.

In some example embodiments, the selected spatial audio signal for a particular device may be that associated with the reference head orientation of the group into which the respective user head orientation from the particular device is arranged.

In some example embodiments, the reference head orientations may comprise orientations for at least one of: the yaw axis; the yaw and pitch axes; or the yaw, pitch and roll axes.

In some example embodiments, the method may be performed by an apparatus comprised by at least one of a user device, or a server.

In some example embodiments, the plurality M of devices may be comprised by at least one of an earphones device, a loudspeaker device or a user device.

According to a third aspect, there is provided a computer program product comprising a set of instructions which, when executed on an apparatus, is configured to cause the apparatus to carry out a method comprising: receiving an audio signal; receiving, from a plurality M of devices, respective requests for a spatial audio signal, wherein the respective requests indicate respective user head orientations; determining a plurality N of reference head orientations, wherein N<M; processing the received audio signal to obtain: a plurality of spatial audio signals respectively associated with the plurality N of reference head orientations; and a plurality of sets of metadata respectively associated with the plurality of spatial audio signals, wherein a set of metadata comprises information indicating how the associated spatial audio signal should be adjusted to account for a change in head orientation related to the associated reference head orientation; and transmitting, to at least one of the devices, a selected spatial audio signal and associated metadata, wherein the selection is based on which reference head orientation is most closely associated with the user head orientation indicated in the request from the at least one device.

The third aspect may also comprise any feature described in relation to the second aspect.

According to a fourth aspect, there is provided a non-transitory computer readable medium comprising program instructions stored thereon for performing a method, comprising: receiving an audio signal; receiving, from a plurality M of devices, respective requests for a spatial audio signal, wherein the respective requests indicate respective user head orientations; determining a plurality N of reference head orientations, wherein N<M; processing the received audio signal to obtain: a plurality of spatial audio signals respectively associated with the plurality N of reference head orientations; and a plurality of sets of metadata respectively associated with the plurality of spatial audio signals, wherein a set of metadata comprises information indicating how the associated spatial audio signal should be adjusted to account for a change in head orientation related to the associated reference head orientation; and transmitting, to at least one of the devices, a selected spatial audio signal and associated metadata, wherein the selection is based on which reference head orientation is most closely associated with the user head orientation indicated in the request from the at least one device.

The fourth aspect may also comprise any feature described in relation to the second aspect.

According to a fifth aspect, there is provided an apparatus comprising: at least one processor; and at least one memory including computer program code which, when executed by the at least one processor, causes the apparatus to: receive an audio signal; receive, from a plurality M of devices, respective requests for a spatial audio signal, wherein the respective requests indicate respective user head orientations; determine a plurality N of reference head orientations, wherein N<M; process the received audio signal to obtain: a plurality of spatial audio signals respectively associated with the plurality N of reference head orientations; and a plurality of sets of metadata respectively associated with the plurality of spatial audio signals, wherein a set of metadata comprises information indicating how the associated spatial audio signal should be adjusted to account for a change in head orientation related to the associated reference head orientation; and transmit, to at least one of the devices, a selected spatial audio signal and associated metadata, wherein the selection is based on which reference head orientation is most closely associated with the user head orientation indicated in the request from the at least one device.

The fifth aspect may also comprise any feature described in relation to the second aspect.

### BRIEF DESCRIPTION OF THE DRAWINGS

Example embodiments will now be described with reference to the accompanying drawings, in which:

FIG. 1 illustrates a system which may be useful for understanding example embodiments;

FIG. 2 illustrates a user when listening to a spatial audio scene which may be useful for understanding example embodiments;

FIG. 3 illustrates the FIG. 2 user when head tracking is not used for the spatial audio scene;

FIG. 4 illustrates the FIG. 2 user when head tracking is used for the spatial audio scene;

FIG. 5 illustrates a split-rendering system which may be useful for understanding example embodiments;

FIG. 6 is a flow diagram showing operations according to one or more example embodiments;

FIG. 7 illustrates a split-rendering system according to one or more example embodiments;

FIG. 8 illustrates a further split-rendering system according to one or more example embodiments;

FIG. 9 is a flow diagram showing operations according to one or more example embodiments;

FIG. 10A and 10B illustrates graphically a clustering operation according to one or more example embodiments;

FIG. 11 illustrates an apparatus which may be configured to operate in accordance with example embodiments; and

FIG. 12 illustrates a non-transitory computer-readable medium for storing computer-readable instructions for causing the FIG. 11 apparatus to operate in accordance with example embodiments.

### DETAILED DESCRIPTION

Example embodiments relate to audio signal processing.

The audio signal may comprise spatial audio data. Spatial audio refers to audio which, when output to a user device such as a pair of earphones, enables a user to perceive audio sources as coming from respective directions with respect to the user's position. For example, one audio source may be perceived as coming from a position in front of the user whereas one or more other audio sources may be perceived as coming from positions to the left and/or right-hand side of the user.

Example formats for spatial audio data may include, but are not limited to, multi-channel mixes, Ambisonics, parametric spatial audio (e.g., metadata-assisted spatial audio (MASA)), object-based audio, or any combination thereof. The spatial audio data may be encoded and decoded using a codec which may comprise, but is not limited to, the 3GPP Immersive Video and Audio Services (IVAS) standard.

In cases where, for example, an audio output device comprises a head-worn device comprising a pair of loudspeakers (examples being a pair of earphones, earbuds, headphones, or an extended reality (XR) headset) the spatial audio data may be rendered using binaural rendering. In binaural rendering, various algorithms may be used by a binaural rendering module of the audio output device, or an associated media player, based on a head-related impulse response (HRIR) or frequency domain equivalent to provide spatial reproduction such that the user perceives the audio sources as if they were positioned within the spatial audio scene.

It may also be possible to perform head-tracking as part of the rendering process. This may involve tracking the position, for example the orientation, of the user's head and compensating or correcting the binaural rendering such that the audio sources are perceived as staying still even if the user's head moves or rotates. This may be performed by providing a reference or “0” orientation, wherein one or more audio sources are perceived from respective spatial positions with respect to the reference orientation. In response to a tracked change in user orientation from the reference orientation to a new orientation, spatial audio scene can be modified so as to compensate for the tracked change so that the user's perception is that the one or more audio sources remain static in the spatial audio scene, which mimics how the user perceives sounds in the real world and provides a strong cue for spatial audio perception. It is commonly known in spatial audio research that reliable head-tracking significantly improves the quality of binaural rendering and allows good perceptual quality even in cases where rendering otherwise might be lacking in accuracy. In some cases, the spatial audio signal representing the spatial audio scene may be modified prior to rendering and, in some cases, the binaural rendering may itself be modified.

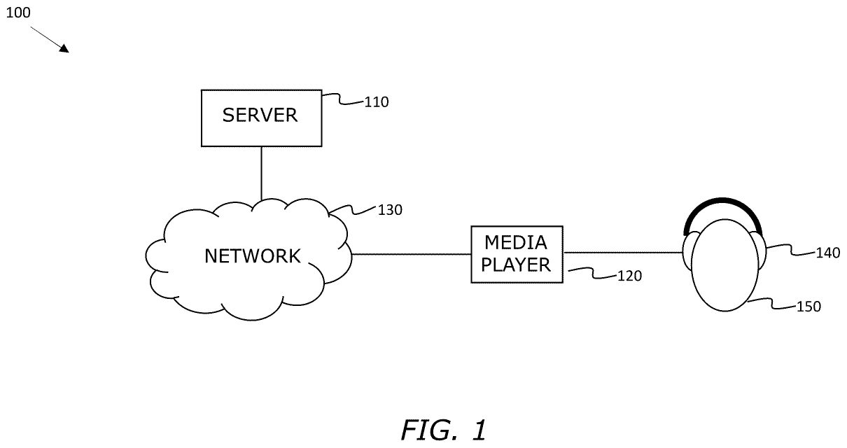

FIG. 1 is a block diagram of a system 100 which may be useful for understanding example embodiments.

The system 100 may comprise a server 110, a media player 120, a network 130 and an audio output device comprising, in this example, set of earphones 140 worn by a user 150.

The server 110 may be connected to the media player 120 by means of the network 130 for sending spatial audio data, to the media player 120. The server 110 may for example comprise an internet protocol (IP) telecommunications server which transmits spatial audio data comprising part of a voice call to the media player 120. The spatial audio data may represent one or more other users which are party to the voice call such that their respective audio data will be perceived from respective directions when rendered by the media player 120 and output to the set of earphones 140. Alternatively, the spatial audio data may represent a music track or an audio track of a movie or a mix of voice and music. Transmission may be by means of any suitable streaming data protocol. Alternatively, or additionally, the server 110 may provide one or more files representing spatial audio data to the media player 120 for storage and processing thereat. At the media player 120, the spatial audio data may be processed and rendered to the set of earphones 140. In example embodiments, the set of earphones 140 may comprise head tracking sensors for providing head-tracking data to the media player 120, indicating, using any suitable method, the user's head orientation or change in user's head orientation, in order to determine how the spatial audio data is to be rendered at the earphones 140. The user's head orientation may be determined in real-time or near real-time using one or more known head-tracking methods, such as by use of one or more inertial sensors (e.g., gyroscopes and/or accelerometers) within, or attached to, the earphones 140. Alternative or additional examples may include using one or more cameras which may identify facial features in real-time.

In some example embodiments, the media player 120 may comprise one of a mobile telephone, a tablet computer, a games console, a laptop computer, a personal computer, a wearable device or any device that comprises or includes a bitstream decoder. In some example embodiments, the media player 120 may comprise part of the set of earphones 140.

The network may be any suitable data communications network including, for example, one or more of a radio access network (RAN) whereby communication is via one or more base stations, a WiFi network whereby communications is via one or more access points, or a short-range network such as one using the Bluetooth or Zigbee protocol.

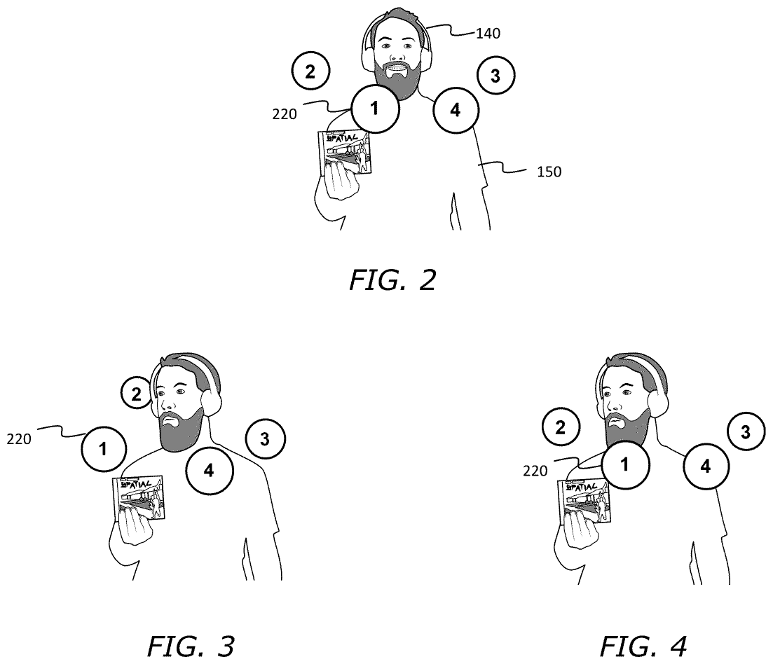

FIGS. 2, 3 and 4 are representational drawings of the user 150 when wearing the set of earphones 140 which may also be useful for understanding example embodiments.

Referring to FIG. 2, the user 150 is shown listening to a rendered spatial audio field comprising first to fourth audio sources (collectively indicated by reference numeral 220) corresponding to distinct respective sounds labelled “1”, “2”, “3” and “4.” Referring to FIG. 3, the respective perceived spatial positions of the first to fourth audio sources 220 are indicated with respect to the user's head in the case that head-tracked rendering is not used. It will be seen that clockwise rotation of the user's head results in no modification of the spatial audio scene and the respective perceived spatial positions of the first to fourth audio sources 220 follow the user's movement. Referring to FIG. 4, the respective perceived spatial positions of the first to fourth audio sources 220 are indicated with respect to the user's head in the case that head-tracked rendering is used, as in the case of example embodiments. It will be seen that clockwise rotation of the user's head results in modification of the spatial audio scene and the respective perceived spatial positions of the first to fourth audio sources 220 do not follow the user's movement and instead remain static.

Spatial audio data can be more complex to transmit, decode and render than other audio formats and hence split rendering methods have been proposed whereby the rendering operation may be divided into different stages, wherein the different stages are performed by different apparatuses. The concept of split rendering may, for example, comprise a first apparatus, or pre-rendering apparatus, for receiving an audio signal and creating a pre-rendered intermediate format of spatial audio signal which can be further rendered by a second apparatus into a consumable format. As will become clear, this may offer advantages in terms of lower complexity at the second apparatus, lower motion-to-sound latency at the second apparatus when using head-tracked rendering and may also offer wider compatibility for different types of second apparatus which can support the pre-rendered intermediate format without necessarily being capable of supporting the audio signal as received by the pre-rendering apparatus.

Example embodiments relate to split-rendering systems comprising first and second types of apparatus.

The first type of apparatus may be referred to as a pre-rendering apparatus. The second type of apparatus, which is separate from the first type of apparatus, may be referred to as a post-rendering device or simply a device.

The pre-rendering apparatus may communicate with a plurality of post-rendering devices.

For example, the pre-rendering apparatus may comprise a user device, a server, or a telecommunications room server. For example, the post-rendering devices may comprise one or more of a user device, a set of earphones with head-tracking capability or a loudspeaker system. Any combination of said examples may be used. In this context, a user device may comprise one of a mobile telephone, a tablet computer, a laptop computer, a personal computer, or wearable device. A set of earphones may comprise earphones which mount over, or adjacent a user's ears, earbuds which may locate at least partly within a user's ears, or speakers of an XR headset. The pre-rendering apparatus may communicate with the plurality of post-rendering devices via wired or wireless channels. The wireless channels may comprise one or more of Bluetooth, Zigbee or WiFi channels, to give some non-limiting examples.

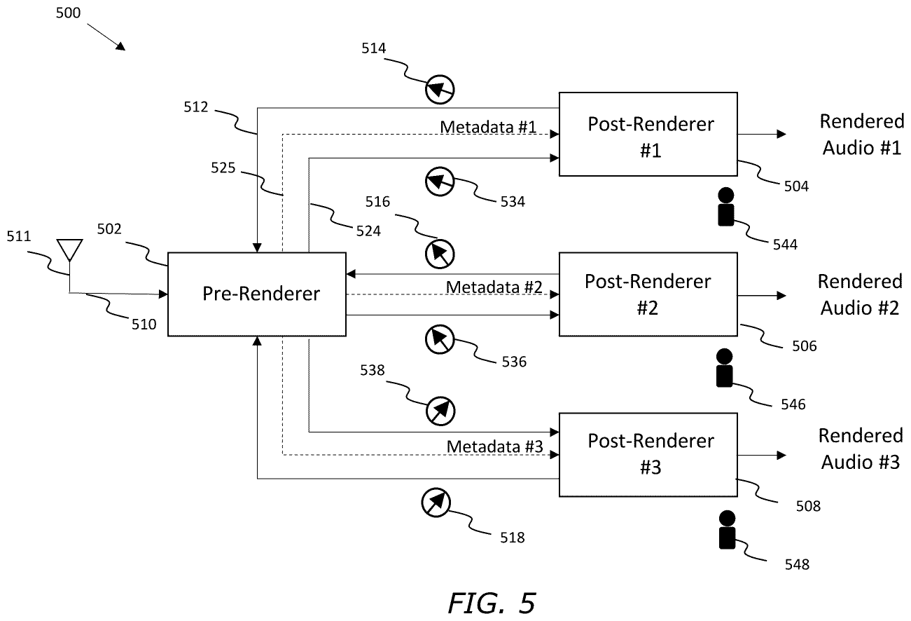

FIG. 5 illustrates a split-rendering system 500 comprising a pre-rendering apparatus 502 in communication with a plurality of post-rendering devices, particularly first, second and third post-rendering devices 504, 506, 508. The first, second and third post-rendering devices 504, 506, 508 may be associated with respective first, second and third users 544, 546, 548 which may be in the same or different locations. The pre-rendering apparatus 502 and the first, second and third post-rendering devices 504, 506, 508 may comprise any combination of the above examples.

The pre-rendering apparatus 502 may receive via an input line 510 an audio signal which may represent a spatial audio scene. The spatial audio scene may comprise a plurality of sound sources, such as those indicated in FIGS. 2-4. The input line 510 may for example be connected to an antenna 511 for receiving the audio signal from a remote source.

The pre-rendering apparatus 502 may be configured to receive from the first, second and third post-rendering devices 504, 506, 508, respective requests for a spatial audio signal, wherein the respective requests indicate respective user head orientations 514, 516, 518.

In examples described herein, user head orientations may refer to head orientations which may comprise at least one of yaw, pitch and/or roll orientations.

For example, the first post-rendering device 504 may transmit via a signal line 512 a request for a spatial audio signal which indicates a first user head orientation 514. The second and third post-rendering devices 506, 508 may transmit their own respective requests which indicate respective second and third user head orientations 516, 518.

The first, second and third user head orientations 514, 516, 518 may represent respective reference or “0” head orientations. The first, second and third user head orientations 514, 516, 518 may for example represent current head orientations of the respective first, second and third users 544, 546, 548, or alternatively may comprise respective reverse directions, average head orientations over a time period or default orientations associated with the first, second and third post-rendering devices 504, 506, 508.

The pre-rendering apparatus 502 may process the audio signal to obtain first, second and third spatial audio signals (alternatively known as intermediate spatial audio signals) respectively associated with the first, second and third user head orientations 514, 516, 518.

For example, the pre-rendering apparatus 502 may perform binaural rendering for each of the first, second and third user head orientations 514, 516, 518 to obtain the first, second and third intermediate spatial audio signals. The pre-rendering apparatus 502 may also obtain first, second and third sets of metadata respectively associated with the first, second and third intermediate spatial audio signals. The first, second and third sets of metadata may comprise information indicating how the associated first, second and third intermediate spatial audio signals may be modified locally at the respective first, second and third post-rendering devices 504, 506, 508 to account for tracked user head positions, in this case changes in orientation, which may be different from the respective first, second and third user head orientations 514, 516, 518.

The pre-rendering apparatus 502 may transmit to the first post-rendering device 504, via a signal line 524, the first intermediate spatial audio signal, and via a signal line 525 the first set of metadata.

Similarly, the pre-rendering apparatus 502 may transmit to the second post-rendering device 506 the second intermediate spatial audio signal and the second set of metadata, and to the third post-rendering device 508 the third intermediate spatial audio signal and the third set of metadata.

As indicated by reference numerals 534, 536, 538, the binaural renderings for the first, second and third intermediate spatial audio signals use orientations which correspond to the respective first, second and third user head orientations 514, 516, 518.

Thus, the first post-rendering device 504 may render the first intermediate spatial audio signal based on the first user head orientation 514 and the first set of metadata may be used to locally modify the first intermediate spatial audio signal to obtain other head orientations as and when they are tracked locally, for example as the user rotates their head away from, or towards, the reference or “0” head orientation. In other words, the first post-rendering device 504 may use the metadata and tracked changes in user head orientation to locally correct binaural cues. The same process may be applied to the second and third spatial audio signals using the second and third sets of metadata received by the second and third post-rendering devices 506, 508. Such a split-rendering approach is mentioned in the 3GPP TSG-SA WG4 Meeting #127bis-e CR document which relates to the IVAS standard specification TS 26.253.

Although less processing may be performed by the first, second and third post-rendering devices 504, 506, 508, because the pre-rendering apparatus 502 needs to obtain and transmit an intermediate spatial audio signal and an associated set of metadata for each of the received first, second and third user head orientations 514, 516, the amount of power and processing resources will increase linearly as the number of post-rendering devices increases. Also, as the number of post-rendering devices increase, it is likely that there will be multiple post-rendering devices that request or require substantially the same spatial audio signal and associated metadata because their respective user head orientations may be the same or substantially the same. The pre-rendering apparatus 502 may therefore be duplicating at least some of the processing.

Example embodiments may avoid or alleviate such issues.

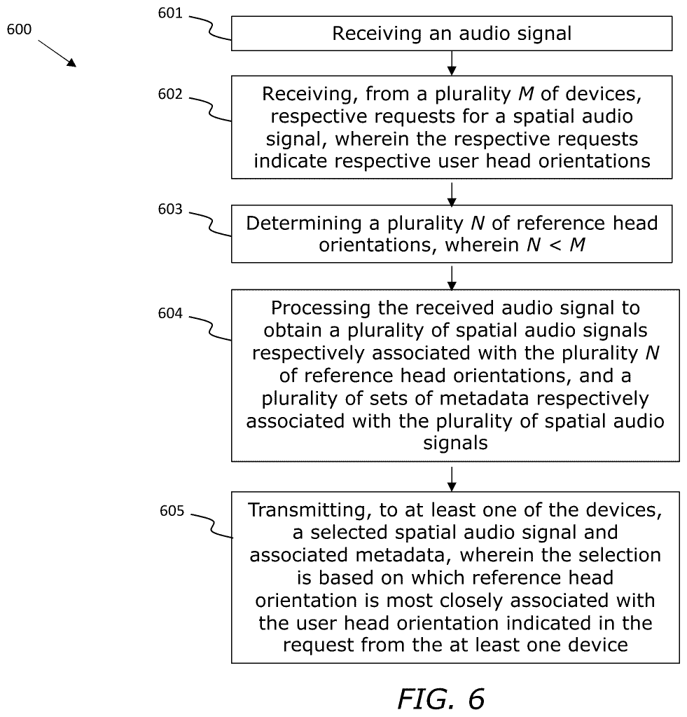

FIG. 6 is a flow diagram showing operations 600 according to one or more example embodiments. The operations 600 may be performed in hardware, software, firmware or a combination thereof. For example, the operations 600 may be performed individually, or collectively, by a means, wherein the means may comprise at least one processor and at least one memory storing instructions that, when executed by the at least one processor, cause the performance of the operations. The operations 600 may, for example, be performed by a pre-processing apparatus.

A first operation 601 may comprise receiving an audio signal.

A second operation 602 may comprise receiving, from a plurality M of devices, respective requests for a spatial audio signal, wherein the respective requests indicate respective user head orientations.

The devices may comprise post-processing devices of any above-described type.

A third operation 603 may comprise determining a plurality N of reference head orientations, wherein N<M.

The third operation 603 may be performed before, during or after performance of the first and second operations 602, 603.

A fourth operation 604 may comprise processing the received audio signal to obtain a plurality of spatial audio signals respectively associated with the plurality N of reference head orientations, and a plurality of sets of metadata respectively associated with the plurality of spatial audio signals.

The term “obtain” may involve generating the plurality of spatial audio signals.

A set of metadata may comprise information indicating how the associated spatial audio signal should be adjusted to account for a change in head position from the associated reference head orientation. The set of metadata may also comprise an indication of the reference head orientation for which the associated spatial audio signal was obtained.

A fifth operation 605 may comprise transmitting, to at least one of the devices, a selected spatial audio signals and associated metadata, wherein the selection is based on which reference head orientation is most closely associated with the user head orientation indicated in the request from the at least one device.

By determining a plurality N of reference head orientations, wherein N is a number less than the number M of devices from which respective requests for spatial audio signals are received, the amount of processing that is required of a pre-processing apparatus is reduced and the pre-processing apparatus may cater for serving a potentially large number of post-processing devices.

In some example embodiments, the term user head orientation may comprise something other than a current actual head orientation of a user, for example a predicted head orientation of the user or some other orientation of or related to the user. For example, one or more of the plurality M of devices may predict a transmission delay for its respective request to have effect and instead requests a predicted user head orientation for a time instance when a spatial audio signal would be received by the respective device.

In some example embodiments, another operation may comprise detecting that the plurality M of devices from which requests are received comprises a number greater than a threshold number G. The fourth and fifth operations 604, 605, and possibly the third operation 603, may be performed responsive to the detecting. If the plurality M of devices comprises a number equal to, or less than, the threshold number G, the process described with reference to FIG. 5 may be performed whereby M spatial audio signals are obtained, respectively associated with M user head orientations indicated in M respective requests from the plurality M of devices.

In some example embodiments, N may comprise any number up to the threshold number G.

In some example embodiments the plurality N of reference head orientations may be determined based at least in part on the respective user head orientations indicated in the respective requests. For example, the plurality N of reference head orientations may be determined in a grouping or clustering operation. Any suitable clustering algorithm may be used, for example k-means clustering wherein the aim is to arrange orientations into N groups whilst minimising variance within the groups. For example, a grouping or clustering operation may comprise arranging the plurality M of user head orientations into N groups of one or more user head orientations, wherein at least one group comprises two or more user head orientations, determining respective reference head orientations for the N groups.

The reference head orientation for said at least one group comprising two or more reference head orientations may be determined based on at least one of said two or more reference head orientations. For example, the reference head orientation for said at least one group may comprise one of the respective user head orientations. Alternatively, the reference head orientation for said at least one group may comprise an average of the respective user head orientations. A group may comprise two or more respective head orientations which are most similar or are within a similarity threshold, for example within a predetermined angular range of one another.

In some example embodiments, and as will be explained in further detail below, the plurality N of reference head orientations may be predetermined, for example in advance of receiving the respective requests.

The FIG. 6 operations 600 will be understood with reference to the following non-limiting example embodiments.

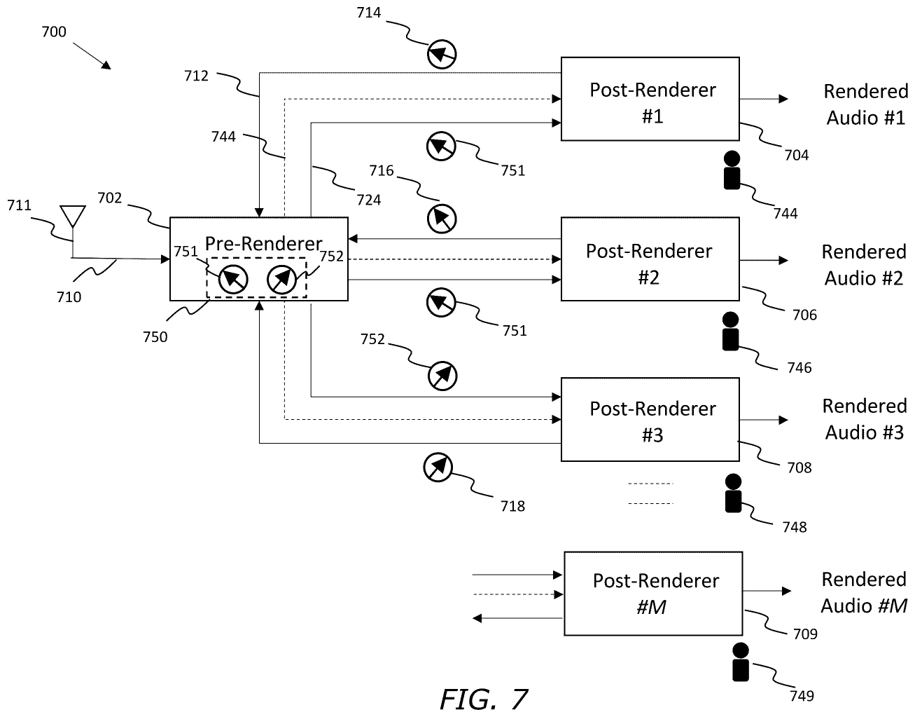

FIG. 7 illustrates a split-rendering system 700 comprising a pre-rendering apparatus 702 in communication with first, second and third post-rendering devices 704, 706, 708. In this case, M=3 but can be a larger number. A further post-rendering device 709 is shown, associated with a further user 749, to indicate that the operations described herein can be extended to any number of M post-rendering devices.

The first, second and third post-rendering devices 704, 706, 708 may be associated with respective first, second and third users 744, 746, 748 which may be in the same or different locations.

The pre-rendering apparatus 702 may receive via an input line 710 an audio signal which may represent a spatial audio scene. The spatial audio scene may comprise a plurality of sound sources, such as those indicated in FIGS. 2-4. The input line 710 may for example be connected to an antenna 711 for receiving the audio signal from a remote source.

The pre-rendering apparatus 702 may be configured to receive from the first, second and third post-rendering devices 704, 706, 708, respective requests for a spatial audio signal, wherein the respective requests indicate respective first, second and third user head orientations 714, 716, 718.

For example, the first user head orientation 714 may equal 280 degrees, the second user head orientation 716 may equal 310 degrees and the third user head orientation 718 may equal 45 degrees. The head orientations 714, 716, 718 may refer to yaw orientations and in other embodiments may refer to at least one of yaw, pitch and/or roll orientations.

For example, the first post-rendering device 704 may transmit via a signal line 712 a request for a spatial audio signal which indicates the first user head orientation 714 of 280 degrees. The second and third post-rendering devices 706, 708 may transmit their own respective requests which indicate the respective second and third user head orientations 716, 718 of 320 and 45 degrees respectively.

The first, second and third user head orientations 714, 716, 718 may represent respective reference or “0” head orientations as described above for FIG. 5.

The pre-rendering apparatus 702 may responsively determine a plurality N of reference head orientations, wherein N<M.

For example, this may be performed in response to the pre-rendering apparatus 702 detecting that M>G which will be the case if G=2, for example, because M=3.

The pre-rendering apparatus 702 may determine a set of two reference orientations 750 comprising first and second reference head orientations 751, 752.

The first and second reference head orientations 751, 752 may be determined based on, in this example, arranging the first and second user head orientations 714, 716 into a first group and the third user head orientation 718 into a second group. Arranging may be performed using any suitable clustering algorithm as mentioned above, for example based on the first and second user head orientations 714, 716 (which are 280 and 310 degrees respectively) being closer to one another than the third user head orientation 718 (which is 45 degrees).

The first reference orientation 751 may comprise one of the first and second user head orientations 714, 716 or an average thereof.

Assuming the latter, the first reference orientation 751 may comprise the average of 280 and 310 degrees, which is 295 degrees.

The second reference orientation 752 may comprise the third user head orientation 718, which is 45 degrees.

The pre-rendering apparatus 702 may process the audio signal to obtain first and second intermediate spatial audio signals, respectively associated with the first and second reference orientations 751, 752 of 295 degrees and 45 degrees (yaw orientation) respectively.

The pre-rendering apparatus 702 may also obtain first and second sets of metadata respectively associated with the first and second intermediate spatial audio signals. The first and second sets of metadata may include an indication of the respective first and reference orientations 751, 752 for which the first and second intermediate spatial audio signals were generated (because these may differ from the orientations that were requested) as well as metadata for correcting or compensating the spatial audio signals based on tracked changes in user orientation from said respective reference orientations. In this way, less processing is required than for the FIG. 5 case, wherein three intermediate spatial audio signals and three sets of associated metadata are obtained.

The pre-rendering apparatus 702 may then transmit selected ones of the first and second intermediate spatial audio signals, and its associated metadata, to the first, second and third post-rendering devices 704, 706, 708 in accordance with the fifth operation 605.

For example, the pre-rendering apparatus 702 may select to transmit the first intermediate spatial audio signal, and its associated metadata, to the first and second post-rendering devices 704, 706. For example, the pre-rendering apparatus 702 may transmit the first intermediate spatial audio signal, via a signal line 724, and the first set of metadata via a signal line 744, to the first post-rendering device 704. This selection is performed on the basis that the first and second user head orientations 714, 716 (which are 280 and 310 degrees respectively) are most closely associated with the first reference orientation 751 of 295 degrees.

For example, the pre-rendering apparatus 702 may select to transmit the second intermediate spatial audio signal, and its associated metadata, to the third post-rendering device 708. This selection is performed on the basis that the third user head orientation 718 of 45 degrees is the same as the second reference orientation 752.

The first, second and third post-rendering devices 704, 706, 708 may then render their received intermediate spatial audio signals to provide rendered audio.

The first, second and third post-rendering devices 704, 706, 708 may, by use of the received sets of metadata, correct the binaural rendering for tracked changes in user orientation in the same way as described for FIG. 5.

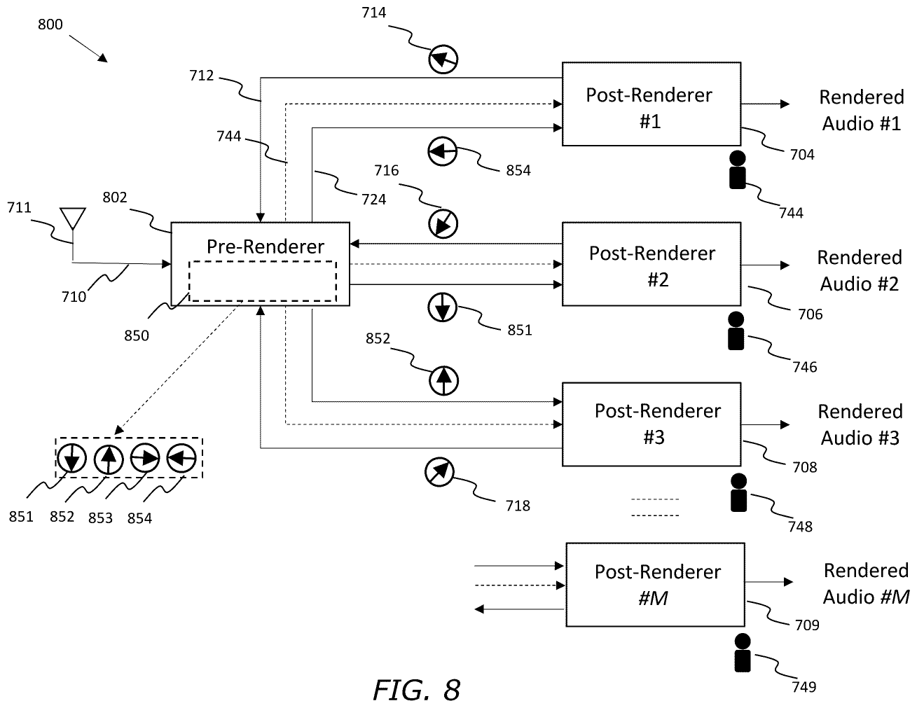

FIG. 8 illustrates a split-rendering system 800 in accordance with another embodiment.

The FIG. 8 system 800 is similar to the FIG. 7 system 700 and comprises a pre-rendering apparatus 802 in communication with at least first, second and third post-rendering devices 704, 706, 708. A further post-rendering device 709 is shown, associated with a further user 749, to indicate that the operations described herein can be extended to any number of M post-rendering devices.

The pre-rendering apparatus 802 in this example comprises a set of reference orientations 850 which include a plurality (N=4) of reference head orientations 851, 852, 853, 854 which may be predetermined in advance of receiving the requests.

For example, a first reference head orientation 851 may comprise 180 degrees, a second reference head orientation 852 may comprise 0 degrees, a third reference head orientation 853 may comprise 90 degrees and a fourth reference head orientation 854 may comprise 270 degrees. The reference head orientations 851, 852, 853, 854 may refer to yaw orientations and in other embodiments may refer to at least one of yaw, pitch and/or roll orientations.

The pre-rendering apparatus 802 may therefore process the audio signal received on input line 710 to obtain first, second, third and fourth intermediate spatial audio signals which are respectively associated with the first, second, third and fourth reference head orientations 851, 852, 853, 854. The pre-rendering apparatus 802 may also obtain four associated sets of metadata as before, wherein the sets of metadata may comprise an indication of the respective first, second, third and fourth reference head orientations 851, 852, 853, 854 for which the first, second, third and fourth intermediate spatial audio signals were generated as well as metadata for correcting or compensating the spatial audio signals based on tracked changes in user orientation from said respective reference orientations.

For example, the processing may be performed in response to the pre-rendering apparatus 802 detecting that M>G.

The plurality N of reference head orientations 851, 852, 853, 854 should be less than M and hence G may be equal to at least 5 in this example and it is assumed that requests have been received from six or more post-rendering devices, although only three post-rendering devices are considered for ease of explanation.

The processing may be performed prior to, during, or after receiving requests from the first, second and third post-rendering devices 704, 706, 708.

In response to receiving a first request from the first post-rendering device 704, the pre-rendering apparatus 802 may determine which of the first, second, third and fourth intermediate spatial audio signals to transmit in response.

For example, if the first request comprises the first user head orientation 714 of 280 degrees, the pre-rendering apparatus 802 may determine that this is most closely associated with the fourth reference head orientation 854 of 270 degrees. The pre-rendering apparatus 802 may therefore select to transmit the fourth intermediate spatial audio signal to the first post-rendering device 704.

Similarly, in response to receiving a second request from the second post-rendering device 706, the pre-rendering apparatus 802 may determine that a second user head orientation 716 of 200 degrees is most closely associated with the first reference head orientation 851 of 180 degrees. The pre-rendering apparatus 802 may therefore select to transmit the first intermediate spatial audio signal to the second post rendering device 706. Similarly, in response to receiving a third request from the third post-rendering device 708, the pre-rendering apparatus 802 may determine that a third user head orientation 718 of 45 degrees is most closely associated with the second reference head orientation 852 of 0 degrees. The pre-rendering apparatus 802 may therefore select to transmit the second intermediate spatial audio signal to the third post rendering device 708. For example, the pre-rendering apparatus 802 may transmit the first intermediate spatial audio signal, via a signal line 724, and the first set of metadata via a signal line 744, to the first post-rendering device 704.

The first, second and third post-rendering devices 704, 706, 708 may then render their received intermediate spatial audio signals to provide rendered audio. The first, second and third post-rendering devices 704, 706, 708 may, by use of the received sets of metadata, correct the binaural rendering for tracked changes in user orientation in the same way as described for FIG. 5.

As before, less processing is required at the pre-rendering apparatus 802 because the number N of intermediate spatial audio signals, and associated sets of metadata, is less than the number M of requesting post-rendering devices.

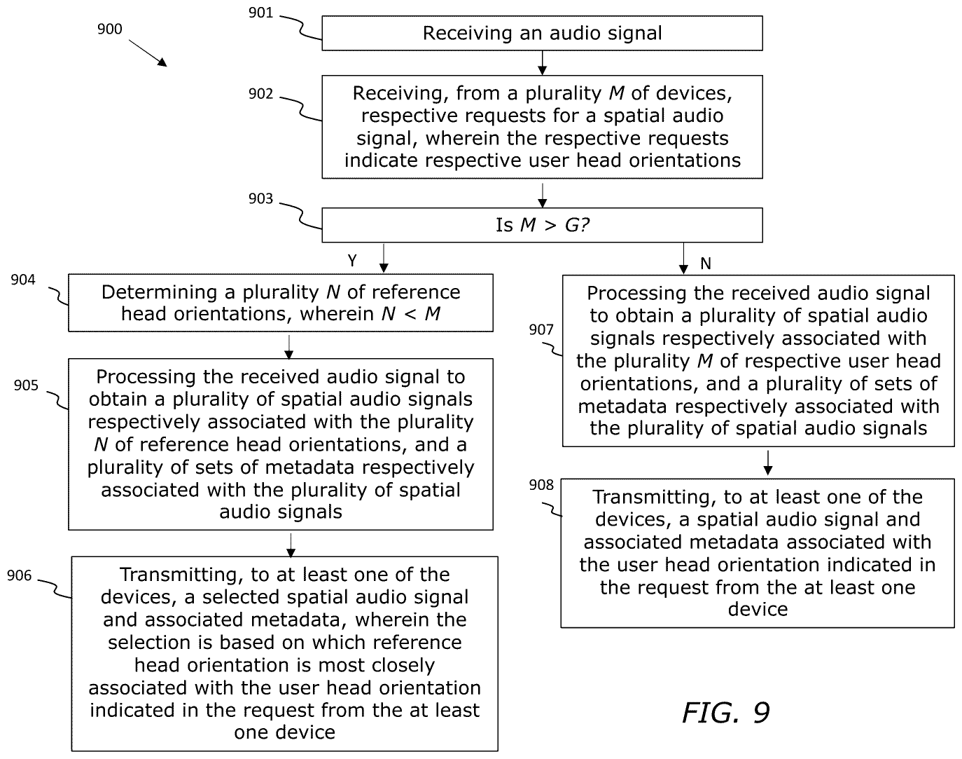

FIG. 9 is a flow diagram showing operations 900 according to one or more example embodiments. The operations 900 may be performed in hardware, software, firmware or a combination thereof. For example, the operations 900 may be performed individually, or collectively, by a means, wherein the means may comprise at least one processor and at least one memory storing instructions that, when executed by the at least one processor, cause the performance of the operations. The operations 900 may, for example, be performed by a pre-processing apparatus.

A first operation 901 may comprise receiving an audio signal.

A second operation 902 may comprise receiving, from a plurality M of devices, respective requests for a spatial audio signal, wherein the respective requests indicate respective user head orientations.

The devices may comprise post-processing devices of any above-described type.

A third operation 603 may comprise determining if M>G, wherein G is a threshold number.

If M>G, a fourth operation 904 may comprise determining a plurality N of reference head orientations, wherein N<M.

A fifth operation 905 may comprise processing the received audio signal to obtain a plurality of spatial audio signals respectively associated with the plurality N of reference head orientations, and a plurality of sets of metadata respectively associated with the plurality of spatial audio signals.

The term “obtain” may involve generating the plurality of spatial audio signals.

A set of metadata may comprise information indicating how the associated spatial audio signal should be adjusted to account for a change in head orientation from the associated reference head orientation. The set of metadata may also comprise an indication of the reference head orientation for which the associated spatial audio signal was obtained.

A sixth operation 906 may comprise transmitting, to at least one of the devices, a selected spatial audio signals and associated metadata, wherein the selection is based on which reference head orientation is most closely associated with the user head orientation indicated in the request from the at least one device.

If M≤G, a seventh operation 907 may comprise processing the received audio signal to obtain a plurality of spatial audio signals respectively associated with the plurality M of user head orientations, and a plurality of sets of metadata respectively associated with the plurality of spatial audio signals.

An eighth operation 908 may comprise transmitting, to at least one of the devices, the spatial audio signal and associated metadata associated with the user head orientation indicated in the request from the at least one device.

Features described in relation to FIG. 6 may be applicable also to FIG. 9.

In some example embodiments, the term user head orientation may comprise something other than a current actual head orientation of a user, for example a predicted head orientation of the user or some other orientation of or related to the user. For example, one or more of the plurality M of devices may predict a transmission delay for its respective request to have effect and instead requests a predicted user head orientation for a time instance when a spatial audio signal would be received by the respective device.

In some example embodiments, certain operations described in relation to FIGS. 6 to 9 may be repeated periodically, for example as often as a new pre-rendering operation would conventionally be performed based in a received audio signal. For example, if the audio signal is received with 20 ms frames, the above operations may be performed every 20 ms. However, to allow for processing time for the above operations, particularly the grouping or clustering operations associated with determining the plurality N of reference head orientations, the grouping or clustering may be performed at greater intervals, for example every 500 ms, or at an even greater period if no significant changes to the indicated user head orientations are observed. The determining of the plurality N of reference head orientations may be updated separately using a different schedule which may be shorter than that used for the grouping or clustering, and potentially for every 20 ms frame.

An orientation may be defined as a rotation from a reference orientation to another orientation. Thus, orientation may be represented similarly to rotations, with examples being Tait-Bryan angles (yaw, pitch, roll), rotation matrices, quaternions, Euler angles or direction cosine matrices. These representations may be converted from one to another using known methods. Further, the above examples assume a single orientation axis, for example one of yaw, pitch and roll. However, when considering head orientations used for binaural rendering, there are limitations in terms of how users move their head. In normal use, most changes in orientation are in the yaw and pitch axes, with yaw being the most significant one. Although the above examples can be extended to use reference orientations corresponding to each of the yaw, pitch and roll axes, a simplified implementation from a computational point-of-view may consider only one or two axes, for example the only yaw axis or the yaw and pitch axes, wherein the roll axis may be set to zero.

With regard to grouping or clustering of user head orientations into two or more groups for determining respective reference head orientations, any suitable clustering algorithm may be used. As mentioned, this may involve k-means clustering wherein the aim is to arrange the respective user head orientations into N groups whilst minimising variance within the groups. The number N of groups may be any number up to the threshold number G. This may be performed by considering corresponding vectors in the yaw axis alone or the yaw and pitch axes. In some example embodiments, if the number M of post-processing devices from which respective requests are received is greater than G, but below a second threshold number, G2, then a simple grouping or clustering algorithm may comprise finding pairs of user head orientations, for example orientations, that have a difference below a predetermined threshold angle A1. Such pairs of user head orientations may be arranged into a common group and the reference head orientation for that group may comprise one of the user head orientations or an average of the pair of user head orientations. If, however, the number M of post-processing devices from which respective requests are received is greater than G and at, or above, the second threshold number, G2, then an alternative grouping or clustering approach may be used. For example, the approach may comprise (i) determining directional vectors associated the respective user head orientations received from the plurality M of devices, (ii) identifying which of a first set of spatial sectors corresponds to a largest number of directional vectors, (iii) dividing the identified spatial sector into two or more spatial sectors, and (iv) if the number of spatial sectors is not equal to N, re-performing the identifying and dividing operations until the number of spatial sectors is equal to N. The plurality M of user head orientations are therefore arranged into N groups and a reference head orientation can be determined for each of the N groups.

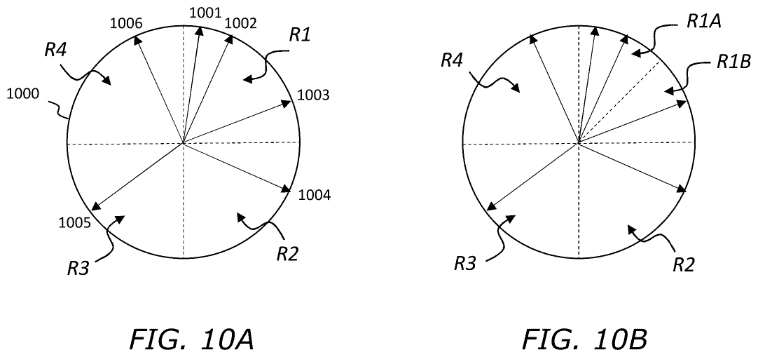

FIG. 10A illustrates an example case where M=6 and N is set to 5.

Six vectors 1001-1006 may be determined which correspond to the M respective user head orientations mapped to a unit circle 1000. Where two or more axes are considered, for example yaw and pitch axes, the vectors 1001-1006 may be mapped to a unit sphere. The unit circle 1000 comprises a first set of four spatial sectors R1-R4 which in this example correspond to quadrants of said unit circle. It can be identified that the first spatial sector R1 comprises the largest number of directional vectors, namely the first, second and third directional vectors 1001, 1002, 1003. If two or more spatial sectors were to comprise the same largest number of directional vectors, a predefined rule may determine which is divided, or alternatively each can be divided provided that N is not exceeded. In this case, the first spatial sector may be divided into two smaller spatial sectors, as illustrated in FIG. 10B, wherein the first spatial sector R1 is replaced by two smaller spatial sectors R1A, R1B. The total number of spatial sectors is now N=5 and so the grouping or clustering process can stop. A reference user head location can be determined for each of the five spatial sectors R1A, R1B, R2, R3 and R4 using the above methods. For example, the first reference head location for the first spatial sector R1A may comprise the average of the first and second user head orientations, represented by the first and second vectors 1001, 1002. For example, the second to fifth reference head locations may comprise the third to sixth user head orientations represented by the third to sixth vectors 1001-1006.

Other approaches for grouping or clustering may involve applying angle quantization in increasing levels of quantization error until there are at most G different orientations left. For example, we may first quantize orientations with 16 bits, and if not enough, we might then quantize with 15 bits, 14 bits and so on. At the point that there are at most G different orientations left, the original orientations can be assigned to groups based on the resulting quantized orientations.

In some example embodiments other implementations may be used.

For example, even if the number M of devices from which requests are received is not greater than G, or when G is small, for example under 10, all pairs of user head orientations may be compared and if any pair is within an inaudible tolerance, e.g., under 5 degrees, of one another, then that pair can be grouped and one of them can be selected for the reference head orientation. This may be trivially extended for larger groups by comparing pairs of reference head orientations to determine if any pair is within the inaudible tolerance, and combining if so. In this way, there is efficient use of power and computational resources without sacrificing perceptual quality.

For example, use of predefined reference orientations, as per the FIG. 8 example, may be useful where the audio signal is served together with video content and/or all of the audio signal is in a relatively narrow direction. It may be more practical and efficient to assign by default one predefined reference orientation for the relatively narrow direction and at least one other predefined reference orientation for unexpected orientations, for example based on other information.

Example embodiments have been described in relation to binaural rendering but are not limited to such an output format and can be used with other output formats.

Example embodiments enable improved power and computational performance for reasons explained above.

### Example Apparatus

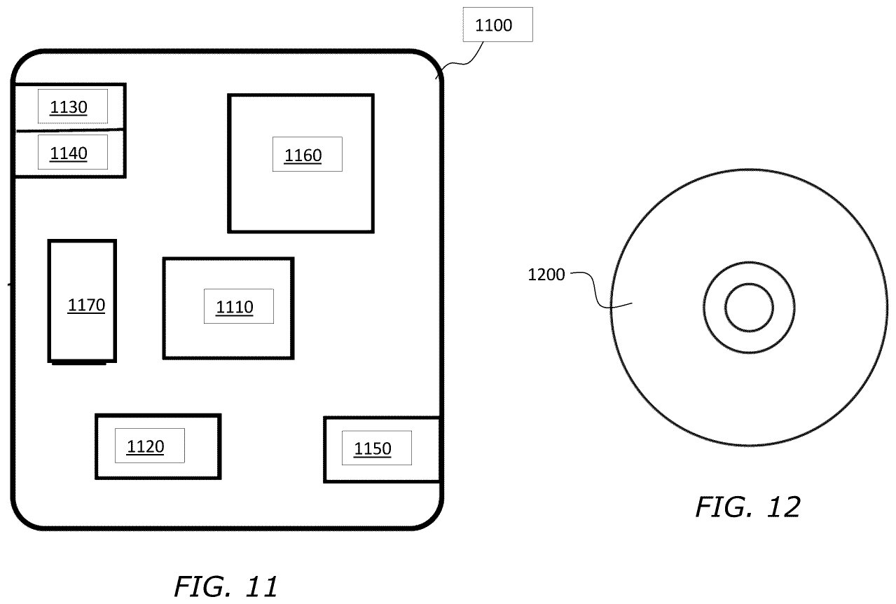

FIG. 11 illustrates an example apparatus 1100 capable of supporting at least some embodiments. Illustrated is a device 1100, which may the above-described pre-rendering apparatus 702, 802. Comprised in device 1100 is a processor 1110, which may comprise, for example, a single-or multi-core processor wherein a single-core processor comprises one processing core and a multi-core processor comprises more than one processing core. The processor 1110 may comprise, in general, a control device. The processor 1110 may comprise more than one processor. The processor 1110 may be a control device. A processing core may comprise, for example, a Cortex-A8 processing core manufactured by ARM Holdings or a Steamroller processing core produced by Advanced Micro Devices Corporation. The processor 1110 may comprise at least one Qualcomm Snapdragon and/or Intel Atom processor. The processor 1110 may comprise at least one Application-Specific Integrated Circuit, ASIC. The processor 1110 may comprise at least one Field-Programmable Gate Array, FPGA. The processor 1110 may be means for performing method steps in device 1100. The processor 1110 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, or a device configured to control the functioning thereof, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The device 1100 may comprise a memory 1120. The memory 1120 may comprise random access memory and/or permanent memory. The memory 1120 may comprise at least one RAM chip. The memory 1120 may comprise solid-state, magnetic, optical and/or holographic memory, for example. The memory 1120 may be at least in part accessible to processor 1110. The memory 1120 may be at least in part comprised in processor 1110. The memory 1120 may be means for storing information. The memory 1120 may comprise computer instructions that processor 1110 is configured to execute. When computer instructions configured to cause the processor 1110 to perform certain actions are stored in the memory 1120, and the device 1100 overall is configured to run under the direction of the processor 1110 using computer instructions from the memory 1120, the processor 1110 and/or its at least one processing core may be considered to be configured to perform said certain actions. The memory 1120 may be at least in part comprised in the processor 1110. The memory 1120 may be at least in part external to the device 1100 but accessible to the device 1100.

The device 1100 may comprise a transmitter 1130. The device 1100 may comprise a receiver 1140. The transmitter 1130 and the receiver 1140 may be configured to transmit and receive, respectively, information in accordance with at least one cellular or non-cellular standard.

The transmitter 1130 may comprise more than one transmitter. The receiver 1140 may comprise more than one receiver. The transmitter 1130 and/or the receiver 1140 may be configured to operate in accordance with Global System for Mobile Communication, GSM, Wideband Code Division Multiple Access, WCDMA, 5G/NR, 5G-Advanced, i.e., NR Rel-18, 19 and beyond, Long Term Evolution, LTE, IS-95, Wireless Local Area Network, WLAN, Ethernet and/or Worldwide Interoperability for Microwave Access, WiMAX, standards, for example.

The device 1100 may comprise a Near-Field Communication, NFC, transceiver 1150. The NFC transceiver 1150 may support at least one NFC technology, such as NFC, Bluetooth, Wibree or similar technologies.

The device 1100 may comprise a User Interface, UI, 1160. The UI 1160 may comprise at least one of a display, a keyboard, a touchscreen, a vibrator arranged to signal to a user by causing device 1100 to vibrate, a speaker and a microphone. A user may be able to operate the device 1100 via the UI 1160, for example to accept incoming telephone calls, to originate telephone calls or video calls, to browse the Internet, to manage digital files stored in memory 1120 or on a cloud accessible via the transmitter 1130 and the receiver 1140, or via NFC transceiver 1150, and/or to play games.

The device 1100 may comprise or be arranged to accept a user identity module 1170. The user identity module 1170 may comprise, for example, a Subscriber Identity Module, SIM, card installable in device 1100. The user identity module 1170 may comprise information identifying a subscription of a user of device 1100. The user identity module 1170 may comprise cryptographic information usable to verify the identity of a user of device 1100 and/or to facilitate encryption of communicated information and billing of the user of the device 1100 for communication effected via device 1100.

The processor 1110 may be furnished with a transmitter arranged to output information from processor 1110, via electrical leads internal to the device 1100, to other devices comprised in the device 1100. Such a transmitter may comprise a serial bus transmitter arranged to, for example, output information via at least one electrical lead to the memory 1120 for storage therein. Alternatively to a serial bus, the transmitter may comprise a parallel bus transmitter.

Likewise, the processor 1110 may comprise a receiver arranged to receive information in The processor 1110, via electrical leads internal to the device 1100, from other devices comprised in the device 1100. Such a receiver may comprise a serial bus receiver arranged to, for example, receive information via at least one electrical lead from the receiver 1140 for processing in the processor 1110. Alternatively to a serial bus, the receiver may comprise a parallel bus receiver.

The device 1100 may comprise further devices not illustrated in FIG. 11. For example, where the device 1100 comprises a smartphone, it may comprise at least one digital camera. Some devices 1100 may comprise a back-facing camera and a front-facing camera, wherein the back-facing camera may be intended for digital photography and the front-facing camera for video telephony. The device 1100 may comprise a fingerprint sensor arranged to authenticate, at least in part, a user of the device 1100. In some embodiments, the device 1100 lacks at least one device described above. For example, some devices 1100 may lack a NFC transceiver 1150 and/or user identity module 1170.

The processor 1110, memory 1120, transmitter 1130, receiver 1140, NFC transceiver 1150, UI 1160 and/or user identity module 1170 may be interconnected by electrical leads internal to the device 1100 in a multitude of different ways. For example, each of the aforementioned devices may be separately connected to a master bus internal to the device 1100, to allow for the devices to exchange information. However, as the skilled person will appreciate, this is only one example and depending on the embodiment various ways of interconnecting at least two of the aforementioned devices may be selected without departing from the scope of the present invention.

FIG. 12 shows a non-transitory media 1200 according to some embodiments. The non-transitory media 1200 is a computer readable storage medium. It may be e.g. a CD, a DVD, a USB stick, a blue ray disk, etc. The non-transitory media 1200 stores computer program instructions, causing an apparatus to perform the method of any preceding process for example as disclosed in relation to the flow diagrams in this specification and related features thereof.

The described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the embodiments in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in dependant claims are mutually freely combinable unless otherwise explicitly stated. Furthermore, it is to be understood that the use of “a” or “an”, that is, a singular form, throughout this document does not exclude a plurality.

1. An apparatus, comprising:
means for receiving an audio signal;
means for receiving, from a plurality M of devices, respective requests for a spatial audio signal, wherein the respective requests indicate respective user head orientations;
means for determining a plurality N of reference head orientations, wherein N<M;
means for processing the received audio signal to obtain:
a plurality of spatial audio signals respectively associated with the plurality N of reference head orientations; and
a plurality of sets of metadata respectively associated with the plurality of spatial audio signals, wherein a set of metadata comprises information indicating how the associated spatial audio signal should be adjusted to account for a change in head orientation related to the associated reference head orientation; and
means for transmitting, to at least one of the devices, a selected spatial audio signal and associated metadata, wherein the selection is based on which reference head orientation is most closely associated with the user head orientation indicated in the request from the at least one device.

2. The apparatus of claim 1, further comprising
means for detecting that the plurality M of devices comprises a number greater than a threshold number G,
wherein the processing is performed responsive to the detecting.

3. The apparatus of claim 2, wherein
the plurality N of reference head orientations comprises a number equal to the threshold number G.

4. The apparatus of any of claims 1 to 3, wherein
the plurality N of reference head orientations are determined in advance of receiving the respective requests.

5. The apparatus of any of claims 1 to 3, wherein
the plurality N of reference head orientations are determined based at least in part on the respective user head orientations indicated in the respective requests.

6. The apparatus of claim 5, wherein:
the plurality N of reference head orientations are determined by:
arranging the plurality M of user head orientations into N groups of one or more user head orientations, wherein at least one group comprises two or more user head orientations; and
determining respective reference head orientations for the N groups,
wherein the reference head orientation for said at least one group comprising two or more reference head orientations is determined based on at least one of said two or more reference head orientations.

7. The apparatus of claim 6, wherein:
the reference head orientation for said at least one group comprises one of the respective user head orientations.

8. The apparatus of claim 6, wherein
the reference head orientation for said at least one group comprises an average of the respective user head orientations.

9. The apparatus of any of claims 6 to 8, wherein
the at least one group comprises two or more respective head orientations which are most similar or are within a similarity threshold.

10. The apparatus of any of claims 6 to 9, wherein:
the arranging comprises:
determining directional vectors associated the respective user head orientations received from the plurality M of devices;
identifying which of a first set of spatial sectors corresponds to the largest number of directional vectors;
dividing the identified spatial sector into two or more spatial sectors; and
if the number of spatial sectors is not equal to N, re-performing the identifying and dividing operations until the number of spatial sectors is equal to N.

11. The apparatus of any of claims 6 to 10, wherein:
the selected spatial audio signal for a particular device is that associated with the reference head orientation of the group into which the respective user head orientation from the particular device is arranged.

12. The apparatus of any preceding claim, wherein
the reference head orientations comprise orientations for at least one of:
the yaw axis;
the yaw and pitch axes; or
the yaw, pitch and roll axes.

13. The apparatus of any preceding claim, wherein:
the apparatus is comprised by at least one of a user device, or a server.

14. The apparatus of any preceding claim, wherein:
the plurality M of devices are comprised by at least one of an earphones device, a loudspeaker device or a user device.

15. A method, comprising:
receiving an audio signal;
receiving, from a plurality M of devices, respective requests for a spatial audio signal, wherein the respective requests indicate respective user head orientations;
determining a plurality N of reference head orientations, wherein N<M;
processing the received audio signal to obtain:
a plurality of spatial audio signals respectively associated with the plurality N of reference head orientations; and
a plurality of sets of metadata respectively associated with the plurality of spatial audio signals, wherein a set of metadata comprises information indicating how the associated spatial audio signal should be adjusted to account for a change in head orientation related to the associated reference head orientation; and
transmitting, to at least one of the devices, a selected spatial audio signal and associated metadata, wherein the selection is based on which reference head orientation is most closely associated with the user head orientation indicated in the request from the at least one device.

16. The method of claim 15, further comprising
detecting that the plurality M of devices comprises a number greater than a threshold number G,
wherein the processing is performed responsive to the detecting.

17. The method of claim 16, wherein
the plurality N of reference head orientations comprises a number equal to the threshold number G.

18. The method of any of claims 15 to 17, wherein
the plurality N of reference head orientations are determined in advance of receiving the respective requests.

19. The method of any of claims 15 to 17, wherein
the plurality N of reference head orientations are determined based at least in part on the respective user head orientations indicated in the respective requests.

20. The method of claim 19, wherein:
the plurality N of reference head orientations are determined by:
arranging the plurality M of user head orientations into N groups of one or more user head orientations, wherein at least one group comprises two or more user head orientations; and
determining respective reference head orientations for the N groups,
wherein the reference head orientation for said at least one group comprising two or more reference head orientations is determined based on at least one of said two or more reference head orientations.

21. The method of claim 20, wherein:
the reference head orientation for said at least one group comprises one of the respective user head orientations.

22. The method of claim 20, wherein
the reference head orientation for said at least one group comprises an average of the respective user head orientations.

23. The method of any of claims 20 to 22, wherein
the at least one group comprises two or more respective head orientations which are most similar or are within a similarity threshold.

24. The method of any of claims 20 to 23, wherein:
the arranging comprises:
determining directional vectors associated the respective user head orientations received from the plurality M of devices;
identifying which of a first set of spatial sectors corresponds to the largest number of directional vectors;
dividing the identified spatial sector into two or more spatial sectors; and
if the number of spatial sectors is not equal to N, re-performing the identifying and dividing operations until the number of spatial sectors is equal to N.

25. A non-transitory computer readable medium comprising program instructions stored thereon for performing a method, comprising:
receiving an audio signal;
receiving, from a plurality M of devices, respective requests for a spatial audio signal, wherein the respective requests indicate respective user head orientations;
determining a plurality N of reference head orientations, wherein N <M;
processing the received audio signal to obtain:
a plurality of spatial audio signals respectively associated with the plurality N of reference head orientations; and
a plurality of sets of metadata respectively associated with the plurality of spatial audio signals, wherein a set of metadata comprises information indicating how the associated spatial audio signal should be adjusted to account for a change in head orientation related to the associated reference head orientation; and
transmitting, to at least one of the devices, a selected spatial audio signal and associated metadata, wherein the selection is based on which reference head orientation is most closely associated with the user head orientation indicated in the request from the at least one device.
